(19) United States
(12) Patent Application Publication
(10) Pub. No.: US 2020/0098263 A1
(43) Pub. Date: Mar. 26, 2020

(54) METHOD AND APPARATUS FOR PROVIDING VEHICLE INFORMATION

(71) Applicant: LG Electronics Inc., Seoul (KR)

(72) Inventor: Nayoung YI, Seoul (KR)

(21) Appl. No.: 16/698,544

(22) Filed: Nov. 27, 2019

(30) Foreign Application Priority Data
Oct. 21, 2019 (KR) 1020190130627

(51) Int. Cl. G08G 1/127; G08G 1/0968; G01C 21/34; G01C 21/36; H04W 4/42; H04W 4/02

(52) U.S. Cl. CPC G08G 1/127; G08G 1/096833; G01C 21/3438; H04W 4/025; G01C 21/3697; H04W 4/42; G01C 21/3453

(57) ABSTRACT

Provided is a method of providing vehicle information, the method which may include identifying a first vehicle associated with a user, identifying first position information associated with a boarding on the first vehicle, identifying a second vehicle allocated for the user to move to a first position based on position information of the user, and providing information associated with the second vehicle.

### CROSS-REFERENCE TO RELATED APPLICATION

This application claims the benefit of Korean Patent Application No. 10-2019-0130627, filed on Oct. 21, 2019, in the Korean Intellectual Property Office, the disclosure of which is incorporated herein in its entirety by reference.

### BACKGROUND

### 1. Field

This disclosure relates to a method and apparatus for providing information on a vehicle moving to a position associated with a user.

### 2. Description of the Related Art

With developments of a navigation system and a communication network, various services have been provided to support a route guidance using public transportations for users traveling by walking, in addition to a route guidance for one's car.

However, such services merely guide positions of stations at which a public transportation (e.g., a public transport bus) for reaching a destination stops and arrival times of public transportations for each station. A user may move by selecting one of stations guided by a subjective decision and thus, may not be guided through an efficient route.

When the user walks to a nearby station to use a public transportation, the walking speed may be less than a speed required in consideration of a distance between a current position of the user and the nearby station. In this case, the user may not arrive until an arrival time of the public transportation, and may miss the public transportation.

Accordingly, there is a desire for a method of providing information on an optimal station for a user to move to a destination and efficiently moving to the optimal station such that the user smoothly gets on a public transportation.

### SUMMARY

An aspect provides a method and apparatus for identifying a position associated with a first vehicle moving to a destination and providing information associated with a second vehicle moving to the identified position, thereby providing an efficient route guidance.

Technical goals of the present disclosure are not limited as mentioned above and, although not mentioned, may include goals that can be clearly understood by those skilled in the art to which the present disclosure pertains, from the following description.

According to an aspect, there is provided a method of providing vehicle information, the method including identifying a first vehicle associated with a user, identifying first position information associated with a boarding on the first vehicle, identifying a second vehicle allocated for the user to move to a first position based on position information of the user, and providing information associated with the second vehicle.

According to another aspect, there is also provided an apparatus for providing vehicle information, the apparatus including at least one processor. The at least one processor is configured to identify a first vehicle associated with a user, identify first position information associated with a boarding on the first vehicle, identify a second vehicle allocated for the user to move to a first position based on position information of the user, and provide information associated with the second vehicle.

According to another aspect, there is also provided a non-transitory computer-readable recording medium including a computer program programed to perform identifying a first vehicle associated with a user, identifying first position information associated with a boarding on the first vehicle, identifying a second vehicle allocated for the user to move to a first position based on position information of the user, and providing information associated with the second vehicle.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 is a diagram illustrating an operation of controlling a vehicle in response to information being transmitted and received between an operating device and a 5G network according to an example embodiment;

FIG. 5 is a block diagram illustrating a wireless communication system to which the methods proposed in the present disclosure are applicable;

FIG. 6 is a diagram illustrating an example of a signal transmission and reception method performed in a wireless communication system;

FIG. 7 is a diagram illustrating a vehicle information providing method according to an example embodiment;

FIG. 8 is a diagram illustrating relationships between devices associated with a vehicle information providing method according to an example embodiment;

FIG. 9 is a functional block diagram of a vehicle information providing apparatus according to an example embodiment;

FIG. 10 is a flowchart illustrating an example of operations of a vehicle information providing method according to an example embodiment;

FIG. 11 is a flowchart illustrating a portion of operations of a vehicle information providing method according to an example embodiment;

FIG. 12 is a flowchart illustrating another portion of operations of a vehicle information providing method according to an example embodiment;

FIG. 13 is a flowchart illustrating another portion of operations of a vehicle information providing method according to an example embodiment;

FIG. 14 is a flowchart illustrating another example of operations of a vehicle information providing method according to an example embodiment;

FIGS. 15 and 16 are diagrams illustrating application examples of a vehicle information providing method according to an example embodiment;

FIG. 17 is a diagram illustrating an example of a screen displayed on a vehicle information providing apparatus according to an example embodiment;

FIG. 18 is a diagram illustrating another example of a screen displayed on a vehicle information providing apparatus according to an example embodiment;

FIG. 19 is a diagram illustrating an example of a screen displayed by a vehicle information providing apparatus on another device according to an example embodiment; and

FIG. 20 is a diagram illustrating another example of a screen displayed by a vehicle information providing apparatus on another device according to an example embodiment.

### DETAILED DESCRIPTION

Exemplary embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables, The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

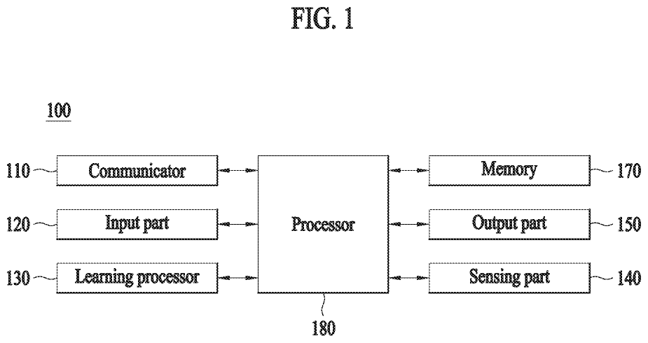

FIG. 1 illustrates an AI device 100 according to an embodiment of the present disclosure.

The AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, a terminal 100 may include a communicator 110, an input part 120, a learning processor 130, a sensing part 140, an output part 150, a memory 170, and a processor 180, for example.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

In this case, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

In this case, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, the learning processor 130 may perform AI processing along with a learning processor 240 of the AI server 200.

In this case, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100 and surrounding environmental information and user information of the AI device 100 using various sensors.

In this case, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

The output part 150 may generate, for example, a visual output, an auditory output, or a tactile output.

In this case, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

In this case, when connection of an external device is necessary to perform the determined operation, the processor 180 may generate a control signal for controlling the external device and may transmit the generated control signal to the external device.

The processor 180 may acquire intention information with respect to user input and may determine a user request based on the acquired intention information.

In this case, the processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the STT engine and/or the NLP engine may have learned by the learning processor 130, may have learned by the learning processor 240 of the AI server 200, or may have learned by distributed processing of the processors 130 and 240.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the A1 device 100 in order to drive an application program stored in the memory 170. Moreover, the processor 180 may combine and operate two or more of the constituent elements of the AI device 100 for the driving of the application program.

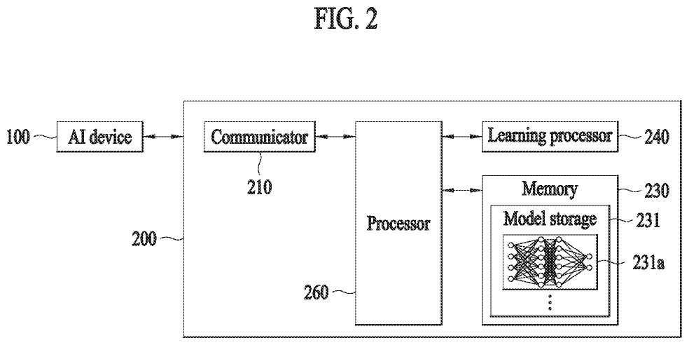

FIG. 2 illustrates the AI server 200 according to an embodiment of the present disclosure.

Referring to FIG. 2, the AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. In this case, the AI server 200 may be included as a constituent element of the AI device 100 so as to perform at least a part of AI processing together with the AI device 100.

The AI server 200 may include a communicator 210, a memory 230, a learning processor 240, and a processor 260, for example.

The communicator 210 may transmit and receive data to and from an external device such as the AI device 100.

The memory 230 may include a model storage 231. The model storage 231 may store a model (or an artificial neural network) 231a which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

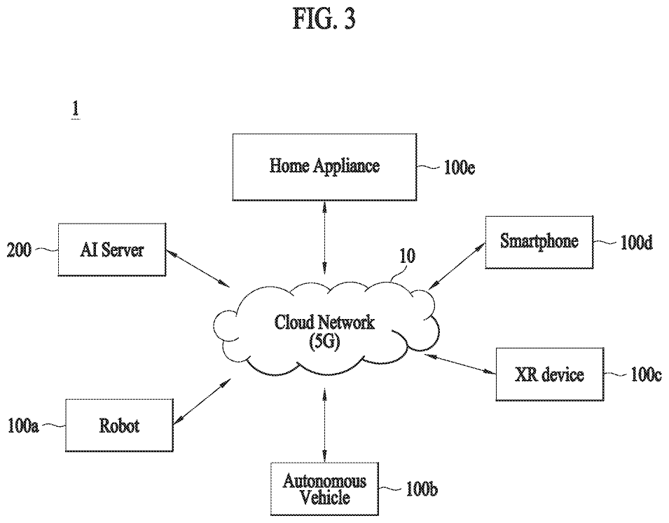

FIG. 3 illustrates an AI system 1 according to an embodiment of the present disclosure.

Referring to FIG. 3, in the AI system 1, at least one of an AI server 200, a robot 100a, an autonomous vehicle 100b, an XR device 100c, a smart phone 100d, and a home appliance 100e is connected to a cloud network 10. Here, the robot 100a, the autonomous vehicle 1001o, the XR device 100c, the smart phone 100d, and the home appliance 100e, to which AI technologies are applied, may be referred to as the AI devices 100a to 100e.

The Cloud network 10 may constitute a part of a cloud computing infra-structure, or may mean a network present in the cloud computing infra-structure. Here, the cloud network 10 may be configured using a 3G network, a 4G or long term evolution (LTE) network, or a 5G network, for example.

That is, the respective devices 100a to 100e and 200 constituting the AI system 1 may be connected to each other via the cloud network 10. In particular, the respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smart phone 100d, and the home appliance 100e, which are AI devices constituting the AI system 1, via the cloud network 10, and may assist at least a part of AI processing of the connected AI devices 100a to 100e.

In this case, instead of the AI devices 100a to 100e, the AI server 200 may cause an artificial neural network to learn according to a machine learning algorithm, and may directly store a learning model or may transmit the learning model to the AI devices 100a to 100e.

In this case, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various embodiments of the AI devices 100a to 100e, to which the above-described technology is applied, will be described. Here, the AI devices 100a to 100e illustrated in FIG. 3 may be specific embodiments of AI device 100 illustrated in FIG. 1.

The autonomous vehicle 100b may be realized into a mobile robot, a vehicle, or an unmanned aerial vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 100b, but may be a separate hardware element outside the autonomous vehicle 100b so as to be connected to the autonomous vehicle 100b.

The autonomous vehicle 100b may acquire information on the state of the autonomous vehicle 100b using sensor information acquired from various types of sensors, may detect (recognize) the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 100a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

In this case, the autonomous vehicle 100b may generate a result using the learning model to perform an operation, but may transmit sensor information to an external device such as the AI server 200 and receive a result generated by the external device to perform an operation.

The autonomous vehicle 100b may determine a movement route and a driving plan using at least one of map data, object information detected from sensor information, and object information acquired from an external device, and a drive part may be controlled to drive the autonomous vehicle 100b according to the determined movement route and driving plan.

The map data may include object identification information for various objects arranged in a space (e.g., a road) along which the autonomous vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, the autonomous vehicle 100b may perform an operation or may drive by controlling the drive part based on user control or interaction. In this case, the autonomous vehicle 100b may acquire interactional intention information depending on a user operation or voice expression, and may determine a response based on the acquired intention information to perform an operation.

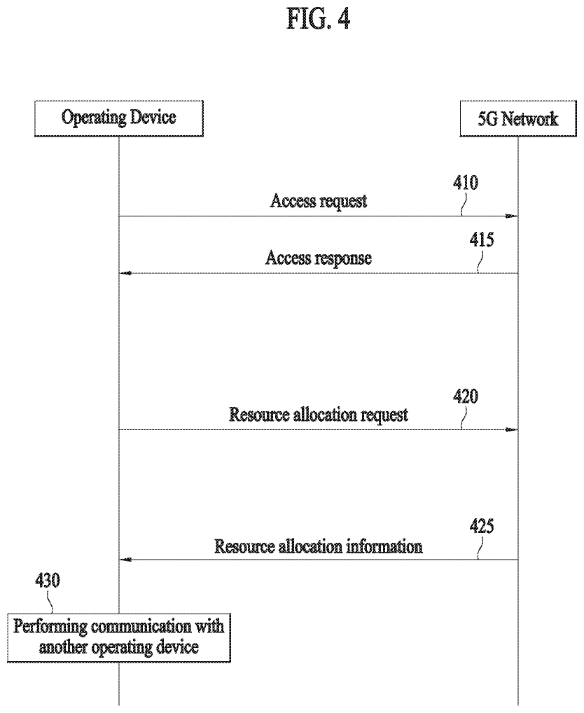

FIG. 4 is a diagram illustrating an operation of controlling a vehicle in response to information being transmitted and received between an operating device and a 5G network according to an example embodiment,

FIG. 4 illustrates a communication method performed between an operating device and a 5G network. In the example embodiment, the operating device may be included in an apparatus for collecting an item. For example, the operating device may be included in a robot for collecting an item.

In operation 410, the operating device may transmit an access request to the 5G network. The access request may be received by a base station and transmitted on a channel for transmitting an access request. The access request may include information for identifying the operating device.

In operation 415, the 5G network may transmit a response to the access request to the operating device. The response to the access request, for example, an access response, may include identification information to be used when the operating device receives information. Also, the access response may include wireless resource allocation information for transmitting and receiving information of the operating device.

In operation 420, the operating device may transmit a wireless resource allocation request for communicating with another device or a base station based on the received information. The wireless resource allocation request may include at least one of information on an operating device and information on a counterpart node for performing communication.

In operation 425, the 5G network may transmit wireless resource allocation information to the operating device. The wireless resource allocation information may be determined based on at least a portion of the information transmitted in operation 420. For example, information associated with resources allocated to communicate with another operating device and identification information to be used for the corresponding communication may be included in the wireless resource allocation information. For example, communication with another operating device may be performed on a channel for device-to-device communication.

In operation 430, the operating device may perform communication with another operating device based on the received information.

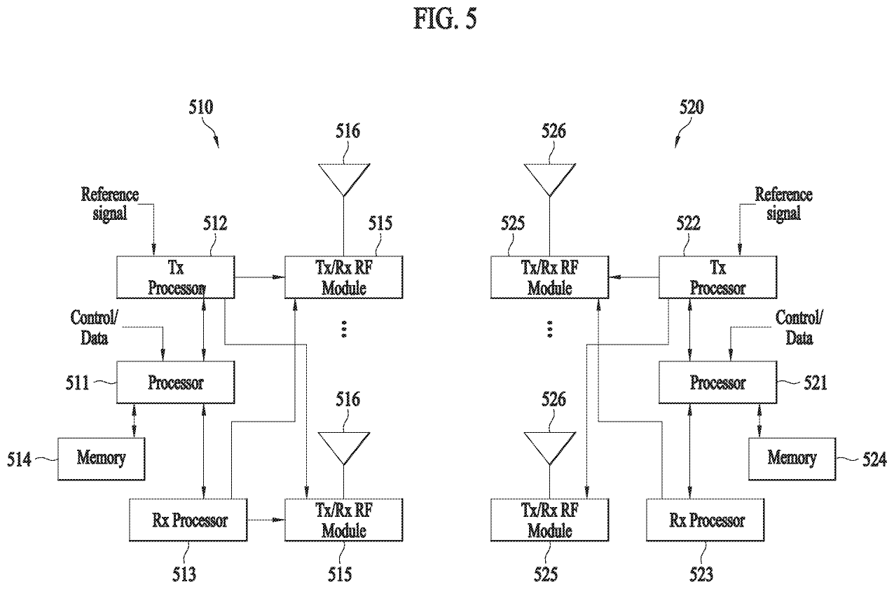

FIG. 5 is a block diagram of a wireless communication system to which a method according to an embodiment of the present disclosure can be applied.

Referring to FIG. 5, an apparatus (an autonomous driving apparatus) including an autonomous driving module may be defined as a first communication device 510, and a processor 511 may perform detailed autonomous driving operations.

A 5G network including another vehicle capable of communicating with the autonomous driving apparatus may be defined as a second communication device 520, and a processor 521 may perform detailed autonomous driving operations.

The 5G network may be expressed as a first communication device, and the autonomous driving apparatus may be expressed as a second communication device.

For example, the first communication device or the second communication device may be a base station, a network node, a Tx terminal, an Rx terminal, a wireless device, a wireless communication device, an autonomous driving apparatus, etc.

For example, a terminal or User Equipment (UE) may include a vehicle, a mobile phone, a smart phone, a laptop computer, a personal digital assistant (PDA), a portable multimedia player (PMP), a navigation, a slate PC, a tablet PC, an ultrabook, a wearable device (e.g., a smartwatch, a smart glass, a head mounted display (HMD)), etc. The HMD may be a display device which can be worn on a user's head. For example, the HMD may be used to realize virtual reality (VR), augmented reality (AR), and mixed reality (MR). Referring to FIG. 1, the first communication device 510 and the second communication device 520 includes processors 511 and 521, memories 514 and 524, one or more Tx/Rx radio frequency (RF) modules 515 and 525, Tx processors 512 and 522, Rx processors 513 and 523, and antennas 516 and 526. A Tx/Rx module may be referred to as transceivers. Each Tx/RX module transmits a signal through the antenna 526. The processor performs the above-described functions, processes, and/or methods. The processor 521 may be related to the memory 524 for storing program codes and data. The memory may be referred to as a computer readable medium. More specifically, in the DL (communication from the first communication device to the second communication), the Tx processor 512 implements various signal processing functions of L1 layer (that is, physical layer). The Rx processor implements various signal processing functions of the L1 layer (that is, physical layer).

The UL (communication from the second communication device to the first communication device) is implemented in the first communication device 510 in a manner similar to the above-description regarding receiver functions in the second communication device 520. Each Tx/Rx module 525 may receive a signal through the antenna 526. Each Tx/Rx module provides a RF subcarrier and information to the Rx processor 523. The processor 521 may be related to the memory 524 for storing program codes and data. The memory may be referred to as a computer readable medium.

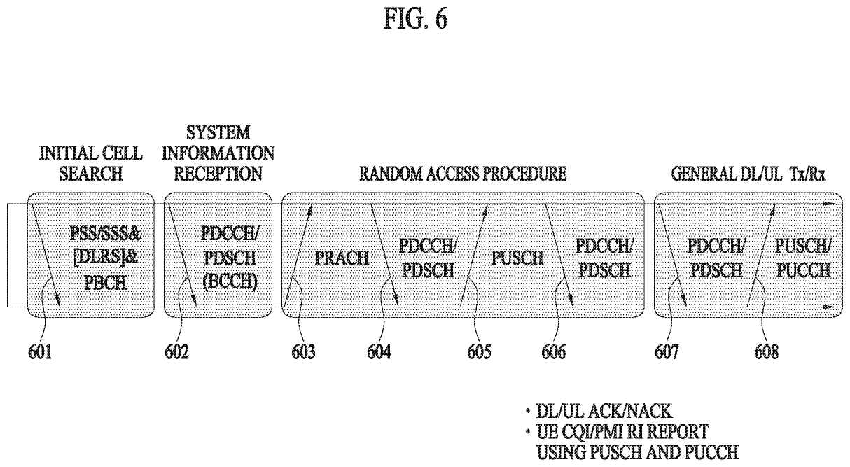

FIG. 6 is a diagram illustrating a method of transmitting and receiving a signal in a wireless communication system according to an example embodiment.

FIG. 6 illustrates an example of a signal transmission/reception method in a wireless communication system.

Referring to FIG. 6, when UE is powered on or enters a new cell, the UE may perform initial cell search such as synchronization with a BS (601). To this end, the UE may receive a primary synchronization channel (P-SCH) and a secondary synchronization channel (S-SCH) from the BS to synchronize with the BS, and may acquire information such as a cell ID. In an LTE system and an NR system, the P-SCH and the S-SCH may be called a primary synchronization signal (PSS) and a secondary synchronization signal (SSS), respectively. After the initial cell search, the UE may acquire broadcast information in the cell by receiving a physical broadcast channel (PBCH) from the BS. Meanwhile, the UE may check the state of a downlink channel by receiving a downlink reference signal (DL RS) during the initial cell search. After completing the initial cell search, the UE may acquire more specific system information by receiving a physical downlink control channel (PDCCH) and a physical downlink shared channel (PDSCH) based on information on the PDCCH (602).

When the UE initially accesses the BS or when there is no radio resource for signal transmission, the UE may perform a random access procedure (RACH) for the BS (603 to 606). To this end, the UE may transmit a specific sequence as a preamble through a physical random access channel (PRACH) (603 and 605), and may receive a random access response (RAR) message for the preamble through the PDCCH and the PDSCH (604 and 606). In the case of contention-based RACH, the UE may additionally perform a contention resolution procedure.

After performing the above-described procedure, the UE may perform, as general uplink/downlink signal transmission procedures, PDCCH/PDSCH reception (607) and physical uplink shared channel (PUSCH)/physical uplink control channel (PUCCH) transmission (208). In particular, the UE may receive downlink control information (DCI) through the PDCCH. The UE may monitor a set of PDCCH candidates at monitoring occasions which are set in one or more control element sets (CORESETs) on a serving cell according to search space configurations. The set of PDCCH candidates to be monitored by the UE may be defined in terms of search space sets, and such a search space set may be a common search space set or a UE-specified search space set. The CORESET is composed of a set of (physical) resource blocks having a time duration of 1 to 3 OFDM symbols. The network may set the UE to have multiple CORESETs. The UE may monitor PDCCH candidates in one or more search space sets. Here, monitoring may refer to attempting to decode PDCCH candidate(s) in a search space. When the UE has succeeded in decoding one of the PDCCH candidates in the search space, the UE may determine that a PDCCH has been detected in a PDCCH candidate, and may perform PDSCH reception or PUSCH transmission based on DCI on the detected PDCCH. The PDCCH may be used to schedule DL transmissions through the PDSCH and UL transmissions through the PUSCH. Here, the DCI on the PDCCH may include downlink assignment (i.e., downlink (DL) grant) including at least modulation, coding format, and resource allotment information associated with a downlink shared channel or uplink (UL) grant including modulation, coding format, and resource allotment information associated with an uplink shared channel.

Referring to FIG. 6, initial access (IA) in the 5G communication system will be further described.

The UE may perform cell search, system information acquisition, beam alignment for initial access, and DL measurement based on an SSB. The SSB may be mixed with a synchronization signal/physical broadcast channel (SS/PBCH) block.

The SSB may be composed of a PSS, an SSS, and a PBCH. The SSB may be composed of four consecutive OFDM symbols, and the PSS, PBCH, SSS/PBCH, or PBCH may be transmitted for each OFDM symbol. Each of the PSS and SSS may be composed of 1 OFDM symbol and 127 subcarriers, and the PBCH may be composed of 3 OFDM symbols and 576 subcarriers.

The cell search may refer to a procedure in which the UE acquires time/frequency synchronization of a cell and detects a cell identifier (ID) (e.g., a physical layer cell ID (PCI)) of the cell. The PSS may be used to detect a cell ID in a cell ID group, and the SSS may be used to detect the cell ID group. The PBCH may be used for SSB (time) index detection and half-frame detection.

There may be 336 cell ID groups, and three cell IDs may exist for each cell ID group. Thus, a total of 1008 cell IDs may exist. Information on a cell ID group, to which a cell ID of a cell belongs, may be provided or acquired through the SSS of the cell, and information on a cell ID among cell IDs of 336 cell ID groups may be provided or acquired through the PSS.

The SSB may be transmitted periodically based on the periodicity of the SSB. An SSB basic period assumed by the UE at the time of initial cell search may be defined as 20 ms. After the cell access, the periodicity of the SSB may be set to one of 5 ms, 10 ms, 20 ms, 40 ms, 80 ms, and 160 ms by a network (e.g., BS).

Next, acquisition of system information (SI) will be described.

The SI may include a master information block (MIB) and multiple system information blocks (SIBs). The SI other than the MIB may be referred to as remaining minimum system Information (RMSI). The MIB may include information/parameters for monitoring the PDCCH which schedules the PDSCH carrying system information block 1 (SIB1), and may be transmitted by the BS through the PBCH of the SSB. The SIB1 may include information on the availability and scheduling (e.g., a transmission period and an SI-window size) of the remaining SIBs (hereinafter, SIBx (x being an integer of 2 or more)). The SIBx may be included in an SI message and may be transmitted through the PDSCH. Each SI message may be transmitted within a time window (i.e., an SI-window) which periodically occurs.

Referring to FIG. 6, random access (RA) in the 5G communication system will be further described.

The random access may be used for various purposes. For example, the random access may be used for network initial access, handover, and UE-triggered UL data transmission. The UE may acquire UL synchronization and UL transmission resources through the random access. The random access may be classified into contention-based random access and contention-free random access. A detailed procedure for the contention-based random access is as follows.

The UE may transmit a random access preamble as an Msg1 of the random access in UL through the PRACH. Random access preamble sequences having two different lengths may be supported. A Long sequence length of 839 may be applied to a subcarrier spacing of 1.25 kHz or 5 kHz, and a short sequence length of 139 may be applied to a subcarrier spacing of 15 kHz, 30 kHz, 60 kHz, or 120 kHz.

When the BS receives the random access preamble from the UE, the BS may transmit a random access response (RAR) message (Msg2) to the UE. The PDCCH which schedules the PDSCH including the RAR may be transmitted by being CRC-masked with a random access (RA) radio network temporary identifier (RNTI) (RA-RNTI). The UE, which has detected the PDCCH masked with the RA-RNTI, may receive the RAR from the PDSCH scheduled by the DCI carried by the PDCCH. The UE may check whether random access response information for the preamble transmitted by the UE, i.e., Msg1, is in the RAR. Whether the random access response information for the Msg1 transmitted by the UE is in the RAR may be determined by whether there is a random access preamble ID for the preamble transmitted by the UE. When there is no response to the Msg1, the UE may retransmit the RACH preamble a predetermined number of times while performing power ramping. The UE may calculate PRACH transmission power for retransmission of the preamble based on the most recent path loss and a power ramping counter.

The UE may transmit, as an Msg3 of the random access, UL transmission through the uplink shared channel based on the random access response information. The Msg3 may include an RRC connection request and an UE identifier. As a response to the Msg3, the network may transmit an Msg4, which may be treated as a contention resolution message in DL. By receiving the Msg4, the UE may enter an RRC-connected state.

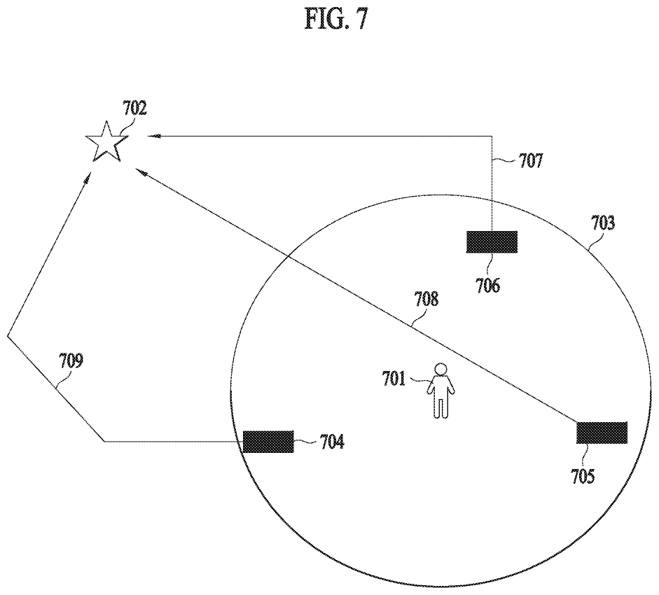

FIG. 7 is a diagram illustrating a vehicle information providing method according to an example embodiment.

Referring to FIG. 7, a user 701 may apply an input requesting a route search for moving to a destination 702 to a vehicle information providing apparatus. When the input requesting the route search is received from the user 701, the vehicle information providing apparatus may search for a route to the destination 702 based on a position of the user 701. The route search may be a route search using a public transport.

Here, the public transport may be a transport means used to transport many people based on a regular line and time schedule such as a bus or a subway, for example. A position at which the public transport stops (hereinafter, referred to as “station”) may be previously designated so that passengers get on and off the public transport at the station.

Specifically, in response to a route search request, the vehicle information providing apparatus may identify at least one station, for example, a first station 704, a second station 705, and a third station 706 within a predetermined radius 703 based on a position of the user 701.

The vehicle information providing apparatus may identify a public transport for moving from each of the at least one identified station 704, 705, and 706 to the destination 702.

For example, in a case of the first station 704, a bus moving to the destination 702 along a first route 709 may be identified. In a case of the second station 705, a bus moving to the destination 702 along a second route 708 may be identified. In a case of the third station 706, a bus moving to the destination 702 along a third route 707 may be identified. Although the public transport is assumed as a bus as an example, embodiments are not limited thereto. The public transport may be understood as various types of public transports.

The vehicle information providing apparatus may select an optimal route based on the user 701 moving to the at least one station 704, 705, and 706, the first route 709, the second route 708, and the third route 707. Also, the vehicle information providing apparatus may provide information on a bus and a station associated with the optimal route, to the user 701.

Although not shown, the vehicle information providing apparatus may provide information on a vehicle (e.g., a shared vehicle) moving to the station associated with an optimal route to the destination 702, in addition to information on a vehicle (e.g., a public transport bus) associated with the optimal route. Related description will be made later.

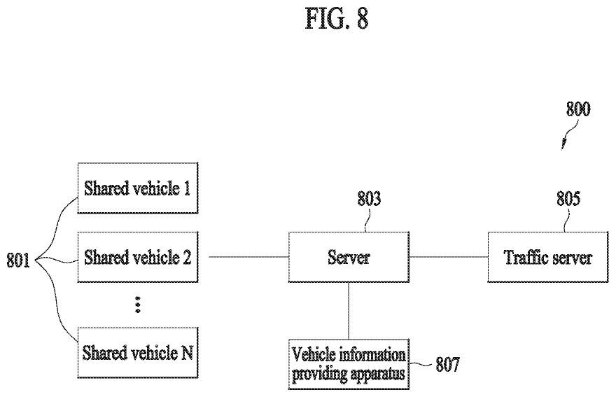

FIG. 8 is a diagram illustrating relationships between devices associated with a vehicle information providing method according to an example embodiment. Specifically, FIG. 8 illustrates an example of a system 800 including devices associated with a vehicle information providing method.

Referring to FIG. 8, a vehicle information providing apparatus 807 may be connected to a server 803. The server 803 may connect a traffic server 805 and a plurality of shared vehicles 801.

The vehicle information providing apparatus 807 may include a user terminal. In this case, the vehicle information providing apparatus 807 may be connected to the server 803 based on an execution of an application allowing an access to the server 803. The vehicle information providing apparatus 807 may provide vehicle information by acquiring a variety of information associated with vehicle information provision from the server 803 based on the connection with the server 803.

The server 803 may be a server of a shared vehicle that manages the plurality of shared vehicles 801. In this example, vehicle information provided by the server 803 to the vehicle information providing apparatus 807 may be information on a portion of the plurality of shared vehicles 801. Specifically, the server 803 may store vehicle type information and seat information of each of the plurality of shared vehicles 801, and provide the stored information to the vehicle information providing apparatus 807.

Also, the server 803 may identify a position, remaining seat information, and a use state of each of the plurality of shared vehicles 801 based on the connection with the plurality of shared vehicles 801.

In the example embodiment, the plurality of shared vehicles 801 may be an autonomous vehicle. The server 803 may use an autonomous driving function to control each of the plurality of shared vehicles 801. For example, the server 803 may control a shared vehicle 1 to move to a predetermined position.

Although FIG. 8 illustrates that the server 803 is independent of the vehicle information providing apparatus 807, the server 803 and the vehicle information providing apparatus 807 may be integrally implemented in some cases. In such cases, a user may use a separate user terminal to transmit an input to the vehicle information providing apparatus 807 or the server 803.

The traffic server 805 may include information on public transport lines and seats for each public transport (e.g., a bus) and may identify information on real-time positions and remaining seats of the public transport lines and information (e.g., traffic volume and floating population of a specific position) acquired by a camera attached to a road side unit (RSU) or road side equipment located near a station.

The RSU may include a sensor (e.g., a camera) attached to a specific position, as would be apparent to one skilled in the art and thus, related description will be omitted. Also, techniques for identifying information such as traffic volume and floating population of a specific position by acquiring information from the RSU would be apparent to one skilled in the art and thus, related description will be omitted.

The connection relationship or inclusion relationship of FIG. 8 is not limited thereto and may be implemented in various ways. Although FIG. 8 illustrates that the server 803 is connected to the traffic server 805 as an example, the traffic server 805 may also be connected to the vehicle information providing apparatus 807. In such a case, the traffic server 805 may provide information directly to the vehicle information providing apparatus 807.

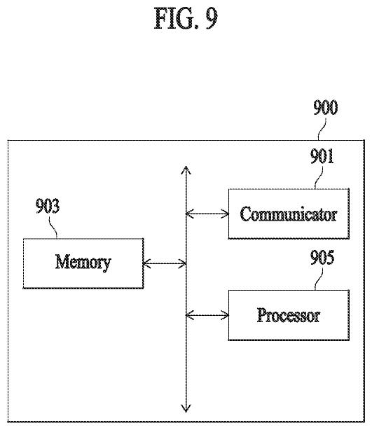

FIG. 9 is a functional block diagram of a vehicle information providing apparatus according to an example embodiment. As used herein, the term “unit” or the like refers to a unit that processes at least one function or operation and may be implemented by hardware or software, or a combination of hardware and software.

Referring to FIG. 9, a vehicle information providing apparatus 900 may include a communicator 901, a memory 903, and a processor 905. The communicator 901 may be implemented by an operating device including a microprocessor, which is the same for the memory 903 and the processor 905 described below.

The communicator 901 may communicate with another device, and transmit and receive information to and from the other device based on the communication. As an example, the communicator 901 may receive information on a shared vehicle from a server (e.g., the server 803) that manages the shared vehicle. As another example, the communicator 901 may receive public transport line information from a server (e.g., the traffic server 805) that manages traffic information.

The memory 903 may store at least one instruction for operation of the vehicle information providing apparatus 900. The at least one instruction stored in the memory 903 may be executed by the processor 905. The below-described operations of the processor 905 may be performed in response to the instruction being executed.

The memory 903 may store a variety of information associated with an operation of the vehicle information providing apparatus 900. For example, when an operation of the vehicle information providing apparatus 900 is performed based on an execution of an application, the memory 903 may store information on the application.

The processor 905 may include at least one processor. In some cases, at least one operation of the processor 905 may be performed by one processor. In some cases, the processor 905 may also be referred to as a controller.

The processor 905 may identify a first vehicle associated with a user. Here, the user may be a user requesting a route guidance to a destination, and the first vehicle may be an optimal public transport means (e.g., a bus) to move the user to the destination.

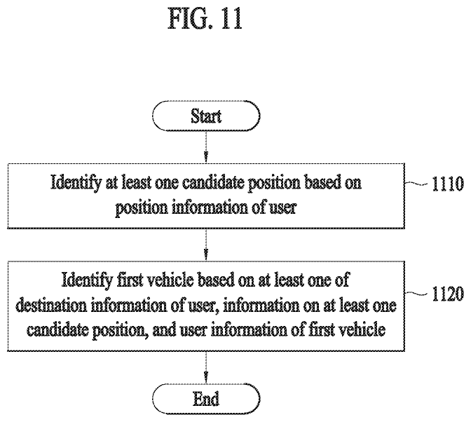

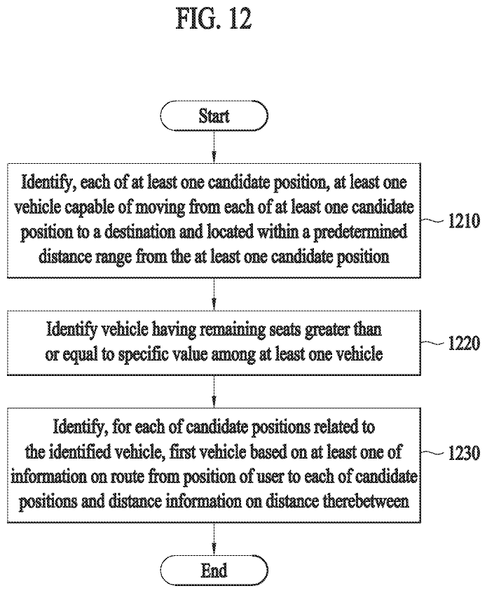

Specifically, the processor 905 may acquire an input of setting a destination from the user. The processor 905 may perform a procedure of identifying the first vehicle for moving to the destination in response to the input being acquired. The procedure of identifying the first vehicle will be described in detail with reference to FIG. 11 or 12.

In the example embodiment, the processor 905 may receive a specific bus number from the user. In this case, the processor 905 may determine a vehicle corresponding to the received bus number to be the first vehicle. For example, when a specific bus number is received, the processor 905 may verify whether a bus corresponding to the received number is present within a predetermined radius from a position of the user. Through such verification, the processor 905 may determine the bus corresponding to the received number present within the predetermined radius (hereinafter, referred to as “designated bus”) to be the first vehicle.

In some cases, the designated bus may be plural. In such cases, the processor 905 may determine the first vehicle based on at least one of a distance, a traffic rule (e.g., left turn, right turn, and U-turn) and remaining seats for each bus. For example, the processor 905 may determine, to be the first vehicle, a vehicle that has remaining seats greater than or equal to a number of people including the user and a companion and has a highest score based on a traffic rule or a distance.

Specifically, in terms of the score, a score of 50 may be assigned in a case in which a travel direction is to be maintained when moving from a position of the user to a station to be stopped in association with each of next stations of the designated bus. When only a right-turn is included in a route, the processor 905 may assign a score of 50. When a left-turn is included in the route, the processor 905 may assign a score of −20. When a U-turn is included in on the route, the processor 905 may assign a score of −40. Also, the processor 905 may assign a score of 50 when a distance from a position of the user to each station to be stopped is less than one kilometer (km), assign a score of 30 when the distance is greater than or equal to 1 km and less than 2 km, and assign a score of 10 when the distance is greater than 2 km.

The processor 905 may identify first position information associated with a boarding on the first vehicle. The first position information may be information on a station at which the first vehicle stops for a passenger to get on and off. The station provided through the first position information may be a station of the first vehicle located within a predetermined radius from a position of the user.

In some cases, when a plurality of vehicles moves to a destination through an optimal route, the processor 905 may determine the plurality of vehicles to be the first vehicle. When stations of the plurality of vehicles determined as the first vehicle are different from one another, a plurality of pieces of information on the stations may be included in the first position information.

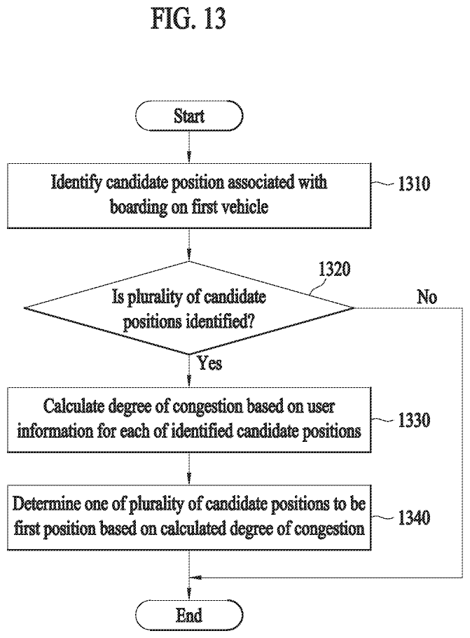

When the first position information includes the plurality of pieces of information on the stations, the processor 905 may select one of the stations as an optimal station and provide information on the optimal station. Selecting the optimal station will be described in detail with reference to FIG. 13.

The processor 905 may be assigned to the user based on position information of the user, for example, a current position of the user. The processor 905 may identify a second vehicle for moving to the first position. The position information of the user may be input by the user or acquired through a measuring device such as a sensor.

When the position of the user is identified, the processor 905 may select the second vehicle for moving from the position of the user to the first position. The second vehicle may be at least one vehicle present in a predetermined distance range from the position of the user among predetermined shared vehicles and may be, for example, an idle vehicle currently out of operation or a vehicle allowed for riding together.

Specifically, the processor 905 may determine one of the at least one vehicle to be the second vehicle based on at least one of information on a distance between a current position of the user and each of the at least one vehicle, information on an item (e.g., a pushchair and a suitcase) belonging to the user, whether riding-together is available, and a number of companions of the user.

In the example embodiment, the processor 905 may acquire information on the item belonging to the user from the user. The processor 905 may determine a vehicle having a room corresponding to a size of the item among at least one vehicle located within a predetermined radius from the position of the user (hereinafter, referred to as “candidate vehicle”), to be the second vehicle based on the acquired information.

For example, the processor 905 may acquire information on a size of the item and a type of the item from an input of the user. In this example, the processor 905 may determine a vehicle having a room corresponding to the size of the item among candidate vehicles, to be the second vehicle.

Space information (e.g., a size of a trunk) of each of the plurality of vehicles may be stored in advance. The processor 905 may include the space information or acquire the space information through a connection with another device, for example, a server.

In the example embodiment, the processor 905 may acquire information on an intention of riding together. The processor 905 may acquire an input about whether to use a riding-together service (hereinafter, referred to as “riding-together option”) from the user. Here, the riding-together option may include information on whether the user is to get on a shared vehicle or whether the user is to allow other people to get on a vehicle in which the user is located.

In response to an input indicating riding together is accepted being acquired for the riding-together option, the processor 905 may add an idle vehicle (or an empty vehicle) and a vehicle in which other users are located, to the candidate vehicles for determining the second vehicle.

In response to an input indicating the riding together is not allowed being acquired for the riding-together option, the processor 905 may add an idle vehicle to the candidate vehicles for determining the second vehicle.

In the example embodiment, the processor 905 may acquire information on companions of the user. For example, the processor 905 may acquire information on a number of companions of the user based on an input of the user. When the user is accompanied by at least one companion, the processor 905 may determine a vehicle having at least two remaining seats among the candidate vehicles to be the second vehicle.

Although the above description is given of a case in which information on the riding-together option, information on the item, and information on the companion are considered individually, embodiments are not limited thereto. For example, at least two of the riding-together option, information on the item, and information on the companion may be considered simultaneously. In this example, the processor 905 may determine a vehicle satisfying all the conditions to be considered among the riding-together option, the information on the item, and the information on the companion, among the candidate vehicles, to be the second vehicle.

When a plurality of vehicles is determined as the second vehicle, the processor 905 may determine one of the plurality of vehicles to be a final second vehicle based on the position information of the user. Specifically, the processor 905 may determine a vehicle located at a position corresponding to a shortest distance from the position of the user (or corresponding to a shortest arrival time) to be the second vehicle.

The present examples are not to be taken as being limited thereto, and the second vehicle may be determined in various ways. For example, the processor 905 may provide information on the determined second vehicles and determine a final second vehicle based on an input of the user selecting one of the second vehicles.

The processor 905 may provide information associated with the second vehicle. Specifically, when the second vehicle is determined, the processor 905 may provide information associated with the second vehicle, for example, information on at least one of a type, a current state, whether a passenger to ride together is present, or an estimated arrival time of the second vehicle. When the vehicle information providing apparatus 900 includes a separate display, the aforementioned information may be displayed on the display. However, embodiments are not limited thereto and, for example, the information may be provided through a transmission to another device.

The second vehicle may move to a position of the user based on the determination made by the processor 905. Such movement of the second vehicle may be realized in various ways. For example, when the second vehicle is a vehicle providing an autonomous driving function, the processor 905 may move the second vehicle to a position of the user by controlling the second vehicle through an access to a server (e.g., the server 803 of FIG. 8) managing the vehicle providing an autonomous driving function. When the processor 905 is included in a server, the processor 905 may directly control the second vehicle.

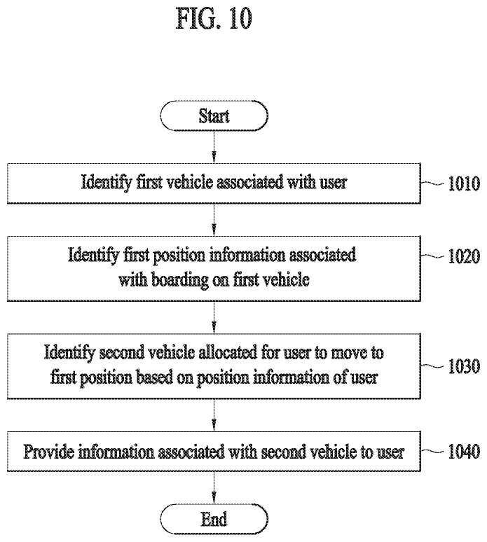

FIG. 10 is a flowchart illustrating an example of operations of a vehicle information providing method according to an example embodiment. Operations illustrated in FIG. 10 may be performed in an order differing from that shown in the drawing in some cases.

Referring to FIG. 10, in operation 1010, the processor 905 may identify a first vehicle associated with a user. The processor 905 may identify the first vehicle based on information on the first vehicle or a destination input from the user. Hereinafter, the information on the first vehicle may also be referred to as “first vehicle information”.

The first vehicle may be, for example, a public transport bus. The first vehicle information may include information on a number of the public transport bus. In the example embodiment, when the first vehicle information is received, the processor 905 may identify the first vehicle located within a predetermined radius from a position of the user. For example, when a bus No. 100 is input as the first vehicle information, the processor 905 may identify a bus of No. 100 within a first radius from a position of the user.

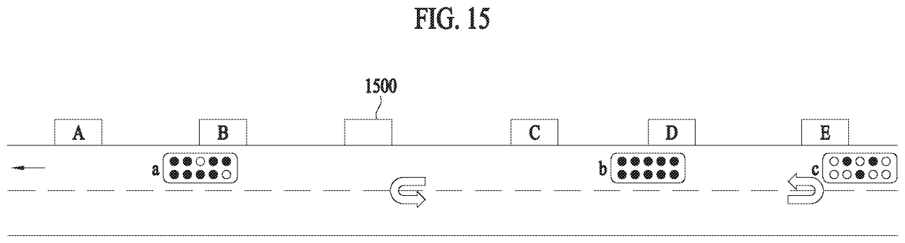

In some cases, when a bus number is input, at least two buses corresponding to the bus number may be present within the first radius. In such cases, the processor 905 may determine the first vehicle among the at least two buses based on at least one of remaining seats, a traffic rule (e.g., a left-turn, a right-turn, and a U-turn), and a distance for each of the buses. For example, the processor 905 may determine, to be the first vehicle, a vehicle that has remaining seats greater than the number of people including the user and a companion and has a highest score based on the traffic rule or the distance. Score calculation may be performed in the same manner as quantification applied in operation 930 of FIG. 12. Also, a reference will be made with an example of FIG. 15 in relation thereto.

In a case in which the destination is input, the first vehicle may be one of vehicles which stop at a station located within a predetermined radius from the destination among public transport buses. Identifying the first vehicle based on a destination input will be described in detail with reference to FIG. 11 or 12.

In the example embodiment, the processor 905 may receive a specific bus number from the user. The processor 905 may determine a vehicle corresponding to the received bus number to be the first vehicle. Related description will be made with reference to FIG. 15.

In operation 1020, the processor 905 may identify first position information associated with a boarding of the first vehicle. The processor 905 may identify first position information on a first position (e.g., a station) at which the first vehicle stops for a passenger to get on or off. The first position information may include information on a position of a station or a route to the station.

In some cases, at least two vehicles may be determined to be the first vehicle. In such cases, because positions of the vehicles correspond to the first position, one position may be selected. When the at least two vehicles are determined to be the first vehicle, the processor 905 may determine a first position further based on user information (e.g., a degree of congestion) for each of the positions of the vehicles. Related description will be made with reference to FIG. 11 or 12.

In operation 1030, the processor 905 may identify a second vehicle allocated for a user to move to the first position based on position information of the user. The processor 905 may acquire position information on a position of the user and identify at least one vehicle present within a predetermined distance range from the position of the user based on the position information. The at least one identified vehicle may be, for example, a shared vehicle present within the range of the distance, among a plurality of predetermined shared vehicles.

The second vehicle may be a vehicle that may move the user from the position of the user to the first position. The processor 905 may determine one of the at least one vehicle to be the second vehicle based on at least one of information on a distance between a current position of the user and each of the at least one vehicle, information on an item (e.g., a pushchair and a suitcase) belonging to the user, whether riding-together is available, and a number of companions of the user.

In the example embodiment, the processor 905 may acquire information on the item belonging to the user from the user. The processor 905 may determine a vehicle having a room corresponding to a size of the item among at least one vehicle located within a predetermined radius from the position of the user (hereinafter, referred to as “candidate vehicle”), to be the second vehicle based on the acquired information.

For example, the processor 905 may acquire information on a size of the item and a type of the item from an input of the user. In this example, the processor 905 may determine a vehicle having a room corresponding to the size of the item among candidate vehicles, to be the second vehicle.

Space information (e.g., a size of a trunk) of each of the plurality of vehicles may be stored in advance. The processor 905 may include the space information or acquire the space information through a connection with another device, for example, a server.

In the example embodiment, the processor 905 may acquire information on an intention of riding together. The processor 905 may acquire an input about whether to use a riding-together service (hereinafter, referred to as “riding-together option”) from the user. Here, the riding-together option may include information on whether the user is to get on a shared vehicle or whether the user is to allow other people to get on a vehicle in which the user is located.

In response to an input indicating riding together is accepted being acquired for the riding-together option, the processor 905 may add an idle vehicle (or an empty vehicle) and a vehicle in which other users are on board, to the candidate vehicles for determining the second vehicle.

In response to an input indicating the riding together is not allowed being acquired for the riding-together option, the processor 905 may add an idle vehicle to the candidate vehicles for determining the second vehicle.

In the example embodiment, the processor 905 may acquire information on companions of the user. For example, the processor 905 may acquire information on a number of companions of the user based on an input of the user. When the user is accompanied by at least one companion, the processor 905 may determine a vehicle having at least two remaining seats among the candidate vehicles to be the second vehicle.

In operation 1040, the processor 905 may provide information associated with the second vehicle to the user. Specifically, the processor 905 may provide information associated with the second vehicle, for example, information on at least one of a type, a current state, whether a passenger to ride together is present, or an estimated arrival time of the second vehicle.

FIG. 11 is a flowchart illustrating a portion of operations of a vehicle information providing method according to an example embodiment. Specifically, FIG. 11 illustrates operation 1010 of FIG. 10 in detail.

Referring to FIG. 11, in operation 1110, the processor 905 may identify at least one candidate position based on position information of a user. Specifically, the processor 905 may identify at least one candidate position within a range of a first distance from a position of the user among a plurality of predetermined candidate positions.

The plurality of candidate positions may be, for example, positions of stations at which a public transport (e.g., a public transport bus) stops. The at least one candidate position may be, for example, a position of a station located within the range of the first distance from the position of the user among the stations at which the public transport stops.

In operation 1120, the processor 905 may identify a first vehicle based on at least one of destination information of the user, information on the at least one candidate position, and user information of the first vehicle.

The destination information of the user may be information on a position of a destination to which the user is to move, and may be acquired from an input of the user.

The information on the at least one candidate position may include at least one of information on a route from a position of the user to each of the at least one candidate position and distance information on a distance from a position of the user to each of the at least one candidate position.

The information on the route may include a length of a route along which a vehicle moves from a position of the user to each of the at least one candidate position and information on a traffic rule (e.g., a left-turn, a right-turn, and a U-turn) included in the route. Specifically, the information on the route may include information on a number of left-turns and a number of U-turns on the route from the position of the user to each of the at least one candidate position and a road travel direction at the position of the user.

The user information of the first vehicle may be information on a user currently located in the first vehicle and include, for example, information on the number of users or the number of remaining seats in the first vehicle.

Identifying the first vehicle will be described in detail with reference to FIG. 12.

FIG. 12 is a flowchart illustrating another portion of operations of a vehicle information providing method according to an example embodiment. Specifically, FIG. 12 illustrates operation 1120 of FIG. 11 in detail.

Referring to FIG. 12, in operation 1210, the processor 905 may identify, for each of at least one candidate position, at least one vehicle capable of moving from each of at least one candidate position to a destination and located within a predetermined distance range from the at least one candidate position.

Specifically, for each of the at least one candidate position, the processor 905 may identify a vehicle capable of moving from the corresponding position to a destination. For example, when the at least one candidate position includes a first candidate position and a second candidate position, the processor 905 may identify a vehicle capable of moving from the first candidate position to a destination and a vehicle capable of moving from the second candidate position to the destination.

The first candidate position and the second candidate position may be stations of public transport lines, and a vehicle capable of moving to the destination through each of the candidate positions may be a public transport, for example, a bus. In this case, since the public transport lines are set in advance, the processor 905 may identify a vehicle for moving from the at least one candidate position to the destination based on public transport line information. The public transport line information may be previously stored or acquired based on a connection with another device (e.g., the traffic server 805).

For each of vehicles capable of moving to the destination, the processor 905 may verify whether a vehicle is located within a predetermined distance range from each candidate position at which such vehicle stops. For example, among vehicles capable of moving to the destination, the processor 905 may identify a vehicle located at a distance less than or equal to a predetermined distance from the candidate position, that is, a vehicle capable of reaching the candidate position within a predetermined time range.

In operation 1220, the processor 905 may identify a vehicle having remaining seats greater than or equal to a specific value among the at least one vehicle. Here, the specific value may be a value determined based on an input of the user. The specific value may be a number of people including the user and companions of the user. For example, when the user is accompanied by two companions, the specific value may be determined to be 3.

The processor 905 may acquire information on remaining seats of each of the at least one vehicle determined through operation 910. For example, the processor 905 may acquire information on remaining seats of each of the at least one vehicle based on a connection with a server that manages the at least one vehicle.

The processor 905 may identify a vehicle having remaining seats greater than or equal to the specific value among the at least one vehicle based on the information on the remaining seats. In other words, the processor 905 may identify a vehicle for accommodating people to move to the destination, including the user.

In operation 1230, for each of candidate positions related to the identified vehicle, the processor 905 may identify or determine the first vehicle based on at least one of information on a route from a position of the user to each of the candidate positions and distance information on a distance therebetween. Here, the identified vehicle may be at least one vehicle.

In the example embodiment, when three vehicles are identified and candidate positions at which the three vehicles stop are the first candidate position, the second candidate position, and a third candidate position, the processor 905 may identify the first vehicle based on information on a route from a position of the user to each of the candidate positions. The information on the route may include information on a number of left-turns and a number of U-turns on the route from the position of the user to each of the at least one candidate position and a road travel direction at the position of the user.

Specifically, the processor 905 may verify whether the user maintains a travel direction of a current position to reach each of the first candidate position, the second candidate position, and the third candidate position and whether each of the left-turn, the right-turn, and the U-turn is included in the route to each of the candidate positions. The processor 905 may perform quantification based on the verified information. Conditions for the quantification may be set in advance.

For example, the processor 905 may assign a score of 50 in a case in which the travel direction is to be maintained. When only the right-turn is included in the route, the processor 905 may assign a score of 50. When the left-turn is included in the route, the processor 905 may assign a score of −20. When the U-turn is included in on the route, the processor 905 may assign a score of −40.

The processor 905 may identify, as the first vehicle, an identified vehicle of a candidate position corresponding to a highest score among the scores quantified for the routes to the first candidate position, the second candidate position, and the third candidate position.

In the example embodiment, the processor 905 may determine the first vehicle among vehicles identified based on the position information of the user. The processor 905 may calculate a distance between a position of the user and a candidate position at which the identified vehicle stops. The processor 905 may perform quantification for each range to which the calculated distance belongs.

For example, the processor 905 may assign a score of 50 when a distance from the user to a candidate position is less than one kilometer (km). When a distance from the user to a candidate position is greater than or equal to 1 km and less than 2 km, the processor 905 may assign a score of 30. When a distance from the user to a candidate position is greater than 2 km, the processor 905 may assign a score of 10.

The processor 905 may identify, as the first vehicle, an identified vehicle of a candidate position corresponding to a highest score among the scores quantified for the candidate positions. However, embodiments are not limited thereto. In some cases, the processor 905 may identify a vehicle that stops at a candidate position from which a calculated distance is the shortest among identified vehicles, as the first vehicle.

In the example embodiment, the processor 905 may identify the first vehicle using distance information and information on a route from a position of the user to each of the candidate positions. In such a case, the processor 905 may obtain a sum of scores calculated using each of the distance information and the information on the route and identify a vehicle identified at a candidate position corresponding to a largest sum of scores, as the first vehicle.

FIG. 13 is a flowchart illustrating another portion of operations of a vehicle information providing method according to an example embodiment. Specifically, FIG. 13 illustrates operation 1020 of FIG. 10 in detail.

Referring to FIG. 13, in operation 1310, the processor 905 may identify a candidate position associated with a boarding on a first vehicle. Specifically, the processor 905 may identify a candidate position for getting on the identified first vehicle.

When a plurality of first vehicles are identified in operation 1010, the processor 905 may identify candidate positions associated with the first vehicles. For example, when the first vehicles are a bus A and a bus B, the processor 905 may identify a first candidate position at which the bus A stops and a second candidate position at which the bus B stops among at least one candidate position.

In operation 1320, the processor 905 may verify whether a plurality of candidate positions is identified. In operation 1330, when the plurality of candidate positions is identified in association with the first vehicle, the processor 905 may calculate a degree of congestion based on user information for each of the identified candidate positions.

Specifically, when the plurality of candidate positions is identified, the processor 905 may calculate a degree of congestion for each of the identified candidate positions based on at least one of a degree of vehicle congestion, a degree of population congestion, or a degree of traffic congestion calculated for each of the candidate positions.

In terms of a degree of vehicle congestion, the processor 905 may acquire information on a real-time vehicle position (e.g., a real-time bus position) and calculate a number of vehicles that stop at each of the candidate positions per predetermined time (e.g., one minute) based on the acquired information. The processor 905 may calculate a degree of vehicle congestion based on a range of the calculated number of vehicles.

For example, the processor 905 may calculate a degree of vehicle congestion to be “10” when the calculated number of vehicles is less than or equal to two, may calculate a degree of vehicle congestion to be “20” when the calculated number of vehicles is greater than two and less than or equal to four, may calculate a degree of vehicle congestion to be “30” when the calculated number of vehicles is greater than four and less than or equal to six, and may calculate a degree of vehicle congestion to be “40” when the calculated number of vehicles is greater than or equal to seven. A degree of vehicle congestion may also be calculated in various schemes, for example, a scheme of assigning a score per number of vehicles, as well as the aforementioned scheme.

In terms of a degree of population congestion, the processor 905 may identify information acquired through a camera attached to an RSU installed at each of the candidate positions. The processor 905 may calculate a number of floating population per predetermined time (e.g., ten minutes) at each of the candidate positions based on the identified information. The processor 905 may calculate a degree of population congestion based on a range of the calculated number of floating population.

For example, the processor 905 may calculate a degree of population congestion to be “5” when the calculated number of floating population is less than or equal to five, may calculate a degree of population congestion to be “10” when the calculated number of floating population is greater than five and less than or equal to ten, may calculate a degree of population congestion to be “15” when the calculated number of floating population is greater than ten and less than or equal to 15, and may calculate a degree of population congestion to be “20” when the calculated number of floating population is greater than 15. A degree of population congestion may also be calculated in various schemes, for example, a scheme of assigning a score per number of floating population, as well as the aforementioned scheme.

Meanwhile, as would be apparent to one skilled in the art, the RSU is a device installed at a fixed position on a roadside to be used for data exchange and communication with a vehicle-mounted device, and related description will be omitted.

In terms of a degree of traffic congestion, the processor 905 may check a traffic flow within a predetermined radius from a candidate position and calculate a degree of traffic congestion based on the traffic flow. In some cases, information on the traffic flow may be acquired from a server (e.g., the traffic server 805 of FIG. 8) that monitors a traffic situation.

The processor 905 may calculate a degree of traffic congestion based on a traffic flow state. For example, the processor 905 may calculate a degree of traffic congestion to be “10” when a traffic flow state is “smooth”, may calculate a degree of traffic congestion to be “20” when a traffic flow state is “normal”, may calculate a degree of traffic congestion to be “30” when a traffic flow state is “relatively severe”, and may calculate a degree of traffic congestion to be “40” when a traffic flow state is “congested.”

The processor 905 may calculate a degree of congestion for each of the candidate positions by obtaining a sum of degrees of the vehicle congestion, the population congestion, and the traffic congestion for each of the candidate positions. However, embodiments are not limited thereto. The processor 905 may calculate a degree of congestion for each of the candidate positions using one or two of the degrees of the vehicle congestion, the population congestion, and the traffic congestion.

When a single candidate position is identified in association with the first vehicle, the processor 905 may perform operation 1030 of FIG. 10.

In operation 1340, the processor 905 may determine one of the plurality of candidate positions to be a first position based on the calculated degree of congestion. The processor 905 may determine a candidate position having a lowest degree of congestion among the plurality of candidate positions, to be the first position based on the calculated degree of congestion.

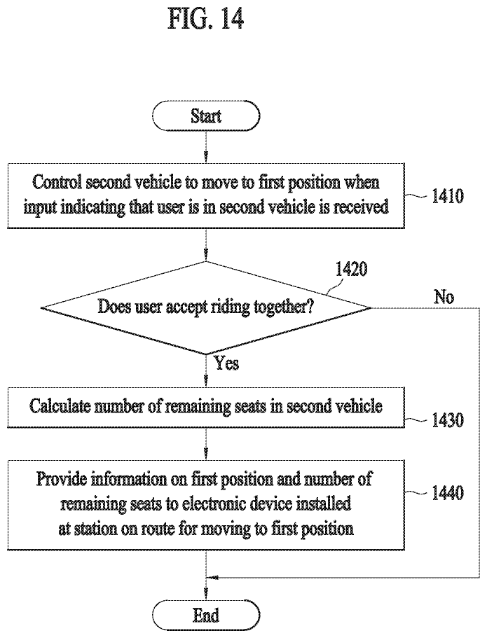

FIG. 14 is a flowchart illustrating another example of operations of a vehicle information providing method according to an example embodiment. Specifically, FIG. 14 illustrates a flow of operations of the vehicle information providing method performed after operation 1040 of FIG. 10.

Referring to FIG. 14, in operation 1410, the processor 905 may control a second vehicle to move to a first position when an input indicating that a user is in the second vehicle is received. The processor 905 may control the second vehicle to move to a position of the user based on position information of the user. Based on this, the user (or the user and a companion) may get on the second vehicle.

When the user is in the second vehicle, the processor 905 may receive the input indicating that the user is in the second vehicle. Such input may be input by the user or acquired by a sensor included in the second vehicle, but not limited thereto.

When the input indicating that the user is in the second vehicle is received, the processor 905 may control the second vehicle to move to the first position. For example, the processor 905 may use a server (e.g., the server 803 of FIG. 8) managing the second vehicle which is an autonomous vehicle, to control the second vehicle to move to the first position.

In operation 1420, the processor 905 may verify whether the user accepts riding together. Information on whether the riding together is accepted may be input from the user before or after the boarding of the user.

As an example, the user may input a destination and information indicating that the riding-together is accepted, at a point in time in which a route search is performed. As another example, when the user is in the second vehicle, the processor 905 may request information on whether to accept riding together from the user. In this example, information indicating whether the riding-together is accepted may be acquired based on a user input corresponding thereto. However, embodiments are not limited thereto, and information indicating whether the riding-together is accepted may be acquired in various ways.

In operation 1430, the processor 905 may calculate a number of remaining seats in the second vehicle. The processor 905 may calculate the number of remaining seats of the second vehicle based on information associated with the second vehicle. The information associated with the second vehicle may include a number of seats in the second vehicle. In this case, the processor 905 may calculate the number of remaining seats in the second vehicle by subtracting the number of users (or users and companions) from the number of seats in the second vehicle.

In operation 1440, the processor 905 may provide information on the first position and the number of remaining seats to an electronic device installed at a station on a route for moving to the first position. The route for moving to the first position may be, for example, an optimal route for moving to the first position used for selecting a first vehicle.

In some cases, a route for the second vehicle to move to the first position may include another position different from the first position, that is, another station. Based on this, the processor 905 may provide information on the first position and the remaining seats of the second vehicle to the other station on the route for moving to the first position.

In such cases, when another user is to move from the other station on the route to the first position, the other user may apply an input representing an intention of riding together and request boarding on the second vehicle in which the user is located.

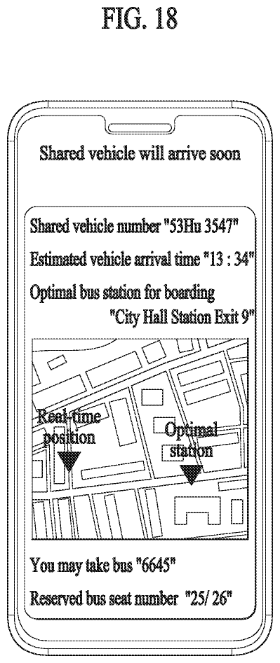

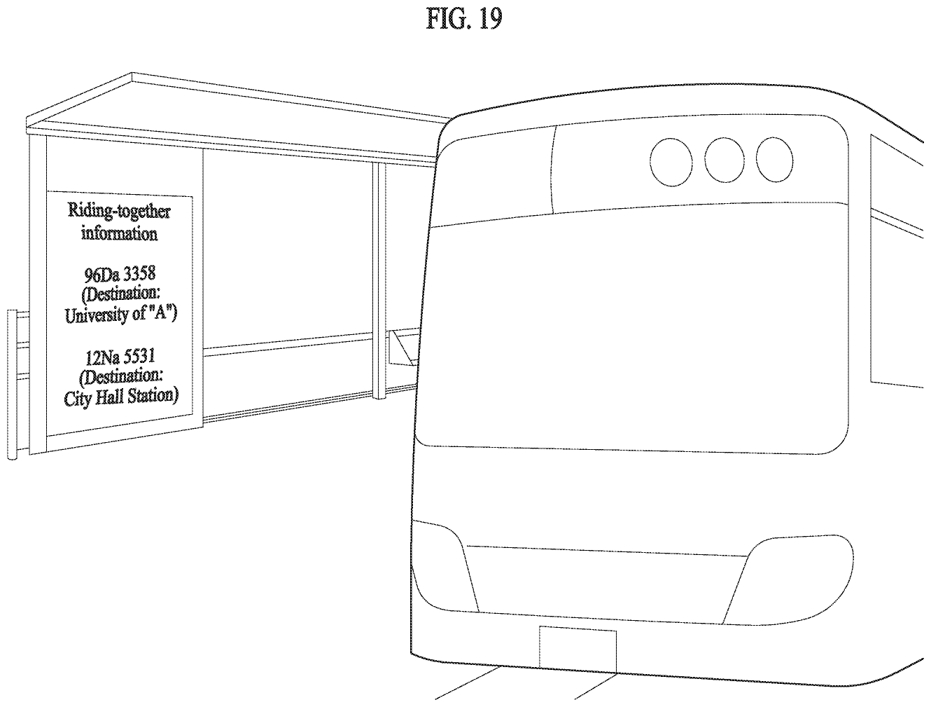

The processor 905 may provide a variety of information associated with the second vehicle to the other station in addition to the information on the number of remaining seats and the first position. An example of providing the information associated with the second vehicle will be further described with reference to FIG. 18 or 19.

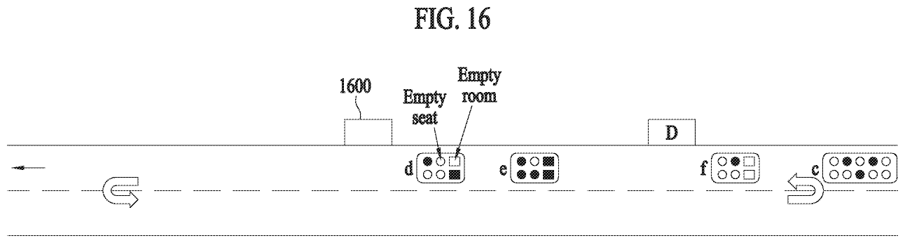

FIGS. 15 and 16 are diagrams illustrating application examples of a vehicle information providing method according to an example embodiment. Specifically, FIG. 15 illustrates an example to which the present disclosure is applied when a bus number of a bus on which the user is to board is designated and when a designated bus stops at a plurality of positions for boarding.

Referring to FIG. 15, a user may input user information and destination information to a vehicle information providing apparatus to go to a destination together with one companion at a first position 1500. Here, the user information may include destination information, a number of companions, position information of the user, a number of belongings, information on whether to ride together, and bus number information of a bus to be used.

The processor 905 may identify destination information, the number of companions, position information of the user, the number of belongings, information on whether to ride together, and bus number information of a bus to be used, based on a user input. The processor 905 may identify a first vehicle in response to the bus number information being acquired.

When an input is acquired, the processor 905 may identify a position associated with the first vehicle, for example, a position of a station at which the first vehicle stops based on the position information of the user. As shown in FIG. 15, the processor 905 may identify A, B, C, D, and E as positions associated with the first vehicle. That is, positions corresponding to A through E may be stations at which the first vehicle stops.

The processor 905 may identify the first vehicle present in a predetermined radius from the first position 1500. Specifically, the processor 905 may identify a vehicle present in the predetermined radius from the first position 1500 among vehicles corresponding to a bus number of the first vehicle. The identified vehicle may be, for example, a, b, and c.

The processor 905 may select a vehicle having remaining seats greater than or equal to the number of users and companions from the identified vehicles. In the example of FIG. 15, selected vehicles may be a and c.

The processor 905 may identify positions for boarding of a and c as at least one candidate position. a and c may be vehicles having the same bus number. In this case, positions associated with a and c may be closest positions corresponding to travel directions of a and c, that is, closest positions at which a and c are to stop. Referring to FIG. 15, a candidate position associated with a may be A, and a candidate position associated with c may be D.

The processor 905 may identify the first vehicle based on at least one of distance information and information on a route from the first position 1500 to each of the at least one candidate position. For example, the processor 905 may identify the first vehicle based on a distance and a route from the first position 1500 to A and a distance and a route from the first position 1500 to D. A result of the identifying may be obtained as a numerical score.

For example, when the user moves toward A, the user may reach A by moving straight and thus, a score of 50 may be assigned based on preset information. Also, since a moving distance is 2.5 km, a score of 10 may be assigned based on preset information. Through this, a total score of 60 may be calculated with respect to A. When the user moves toward D, a U-turn may be required and thus, a score of −40 may be assigned. Also, since a moving distance is 1 km, a score of 30 may be assigned based on preset information. Through this, a total score of −10 may be calculated with respect to D.

The processor 905 may determine, to be the first vehicle, a vehicle which stops at a position corresponding to a greater score between the calculated scores. When the calculated scores are the same, the processor 905 may calculate degrees of congestion of A and D and determine a which is a vehicle that stops at a lower degree of congestion, to be the first vehicle. The degrees of congestion may be calculated after the calculated scores are determined to be the same, but not limited thereto.

FIG. 16 illustrates an example of arranging a second vehicle when c is determined as the first vehicle.

Referring to FIG. 16, the processor 905 may determine a second vehicle based on a travel time for moving from a position of each of a plurality of vehicles (e.g., d, e, and f) which are candidates for the second vehicle, to a first position 1600 at which a user is located, and a travel time for moving to an optimal station D after boarding of the user.

Specifically, the processor 905 may identify d, e, and f which are at least one vehicle located within a predetermined range from the first position 1600. For example, d, e, and f may be vehicles present within a predetermined range from the first position 1600 among shared vehicles registered in a shared vehicle server. When the processor 905 acquires information indicating riding-together is not accepted from the user, d, e, and f may be empty vehicles, that is, idle vehicles.

The processor 905 may acquire information on an item belonging to the user and information on a companion from the user. In this case, from d, e, and f, the processor 905 may select a vehicle having remaining seats for the user and the companion and a room for the item. Referring to FIG. 16, when information indicating that the user has two belongings and one companion is acquired, the processor 905 may determine f which has at least two rooms for the belongings and at least two remaining seats, to be the second vehicle.

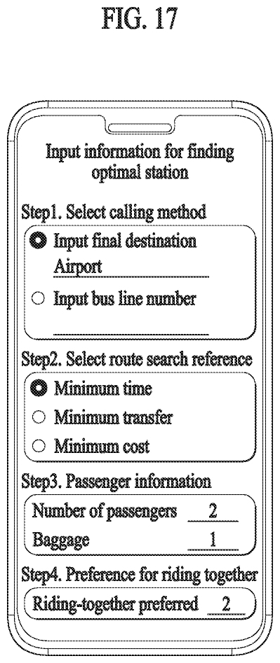

FIG. 17 is a diagram illustrating an example of a screen displayed on a vehicle information providing apparatus according to an example embodiment. Specifically, FIG. 17 illustrates a screen displayed to acquire user information.

As illustrated in FIG. 17, a field to input a destination or a bus line number may be displayed. Also, a field for selecting a route search reference may also be displayed. A route search for each reference may be performed using various techniques in related arts.

A user terminal may display fields to input information on a number of people including a user and information on a number of items belonging to the user as user information. Here, the number of people may be a number of people to use a second vehicle, including the user and a companion. The user terminal may also display a field to input information on whether to ride together.

FIG. 18 is a diagram illustrating another example of a screen displayed on a vehicle information providing apparatus according to an example embodiment.

When a second vehicle (hereinafter, referred to as “shared vehicle”) is determined, a vehicle information providing apparatus may provide information associated with the second vehicle to a user. In this case, the processor 905 may provide the user with a screen as illustrated in FIG. 18.

Referring to FIG. 18, the information provided to the user may including a number of the shared vehicle, an estimated arrival time, first position information indicating an optimal station for boarding on a bus, and information on a number of a first vehicle corresponding to a bus to be boarded. Also, a reservation of a seat may be made to use the first vehicle. In this case, information on a seat number of the reserved bus may also be provided.

FIG. 19 is a diagram illustrating an example of a screen displayed by a vehicle information providing apparatus on another device according to an example embodiment.

Referring to FIG. 19, when the user accepts riding together, information associated with a second vehicle may be provided to a station within a predetermined radius from a route on which the second vehicle moves. The information on the second vehicle may include a vehicle number and information on a first position corresponding to a destination to which the second vehicle moves.

In this case, another user located in the station may request riding-together based on the provided information. When the riding-together is requested, the processor 905 may control the second vehicle to move to the first position through the station at which the riding-together request is sent.

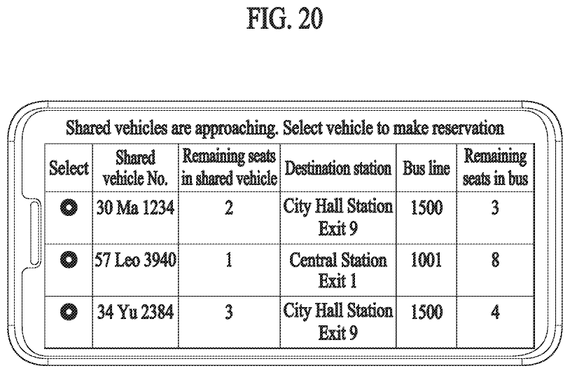

FIG. 20 is a diagram illustrating another example of a screen displayed by a vehicle information providing apparatus on another device according to an example embodiment. Specifically, FIG. 20 illustrates another example of the information displayed at the station of FIG. 19.

Referring to FIG. 20, as information associated with the second vehicle, information on remaining seats, information associated with a first vehicle, and information on remaining seats in the first vehicle may be provided. The provided information associated with the second vehicle may be in a form as illustrated in FIG. 20 in addition to a form as illustrated in FIG. 19.

According to example embodiments, it is possible to provide a vehicle information providing method and apparatus that identifies a first vehicle efficiently moving to a destination and provides related position information, thereby providing an effective guidance of a route to a destination.

According to example embodiments, it is possible to provide a vehicle information providing method and apparatus that provides information associated with a second vehicle moving to a position related to a first vehicle such that a user travels to a destination with increased convenience and efficiency.

Effects are not limited to the aforementioned effects, and other effects not mentioned will be clearly understood by those skilled in the art from the description of the claims.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

The above description is merely illustrative of the technical idea of the present disclosure, and those skilled in the art to which the present disclosure pertains may make various modifications and changes without departing from the essential quality of the present disclosure. Accordingly, the embodiments disclosed herein are not intended to limit the technical spirit of the present disclosure but to describe the present disclosure, and the scope of the technical spirit of the present disclosure is not limited by these embodiments. The scope of protection of the present disclosure should be interpreted by the following claims, and all technical ideas that fall within the scope of equivalents thereof should be construed as being included in the scope of the present disclosure.

What is claimed is:

1. A method of providing vehicle information, the method comprising:
identifying a first vehicle associated with a user;
identifying position information associated with a boarding on the first vehicle;
identifying a second vehicle allocated for the user to move to a first position based on user information associated with position of the user; and
providing information associated with the second vehicle.

2. The method of claim 1, wherein the identifying of the first vehicle comprises:
identifying the first vehicle based on at least one of identification information of the first vehicle and destination information of the user.

3. The method of claim 1, wherein the identifying of the first vehicle comprises:
identifying at least one candidate position based on the user information; and
identifying the first vehicle based on at least one of destination information of the user, information on the at least one candidate position, and information of user using the first vehicle.

4. The method of claim 3, wherein the identifying of the at least one candidate position comprises:
identifying at least one candidate position within a range of a first distance from a position of the user among a plurality of predetermined candidate positions.

5. The method of claim 3, wherein the information on the at least one candidate position includes at least one of information on a route from a position of the user to each of the at least one candidate position and distance information on a distance from a position of the user to each of the at least one candidate position.

6. The method of claim 5, wherein the information on the route includes information on a number of left-turns and a number of U-turns on the route from the position of the user to each of the at least one candidate position and a road travel direction at the position of the user.

7. The method of claim 1, wherein when the position information includes information on at least two positions, the identifying of the position information comprises:
identifying the first position further based on information of user associated with the at least two positions.

8. The method of claim 1, further comprising:
acquiring state information of the user,
wherein the identifying of the second vehicle further comprises identifying the second vehicle further based on the state information of the user, and the state information of the user includes information on at least one of whether the user is to ride together, a type and number of items belonging to the user, and a number of people to use a shared vehicle along with the user, including the user.

9. The method of claim 1, wherein the second vehicle includes a shared vehicle capable of autonomous driving and moves to a position of the user in response to the second vehicle being identified.

10. An apparatus for providing vehicle information, the apparatus comprising:
at least one processor,
wherein the at least one processor is configured to:
identify a first vehicle associated with a user;
identify position information associated with a boarding on the first vehicle;
identify a second vehicle allocated for the user to move to a first position based on user information associated with position of the user; and
provide information associated with the second vehicle.

11. The apparatus of claim 10, wherein the at least one processor is configured to identify the first vehicle based on at least one of identification information of the first vehicle and destination information of the user.

12. The apparatus of claim 10, wherein the at least one processor is configured to identify at least one candidate position based on the user information and identify the first vehicle based on at least one of destination information of the user, information on the at least one candidate position, and information of user using the first vehicle.

13. The apparatus of claim 12, wherein the at least one processor is configured to identify at least one candidate position within a range of a first distance from a position of the user among a plurality of predetermined candidate positions.

14. The apparatus of claim 12, wherein the information on the at least one candidate position includes at least one of information on a route from a position of the user to each of the at least one candidate position and distance information on a distance from a position of the user to each of the at least one candidate position.

15. The apparatus of claim 14, wherein the information on the route includes information on a number of left-turns and a number of U-turns on a route from the position of the user to each of the at least one candidate position and a road travel direction at the position of the user.

16. The apparatus of claim 10, wherein when the position information includes information on at least two positions, the at least one processor is configured to identify the first position further based on information of user associated with the at least two positions.

17. The apparatus of claim 10, wherein the at least one processor is configured to acquire state information of the user and identify the second vehicle further based on the state information of the user, and
the state information of the user includes information on at least one of whether the user is to ride together, a type and number of items belonging to the user, and a number of people to use a shared vehicle along with the user, including the user.

18. The apparatus of claim 10, wherein the second vehicle includes a shared vehicle capable of autonomous driving and moves to a position of the user in response to the second vehicle being identified.

19. A non-transitory computer-readable recording medium comprising a computer program programmed to perform:
identifying a first vehicle associated with a user;
identifying first position information associated with a boarding on the first vehicle;
identifying a second vehicle allocated for the user to move to a first position based on position information of the user; and
providing information associated with the second vehicle.
